(19) United States
(12) Patent Application Publication
(10) Pub. No.: US 2022/0030901 A1
(43) Pub. Date: Feb. 3, 2022

(54) CREAM CHEESE

(71) Applicant: SAVENCIA SA, VIROFLAY (FR)

(72) Inventors: Fabien Durand, Razac sur L'Isle (FR); Virginie PADEL, FAVIERES (FR); Alice CIBRARIO, Versailles (FR)

(73) Assignee: SAVENCIA SA, VIROFLAY (FR)

(21) Appl. No.: 17/389,797

(22) Filed: Jul. 30, 2021

(30) Foreign Application Priority Data
Jul. 31, 2020 (FR) FR 2008200

(51) Int. Cl. A23C 20/02; A23L 25/00; A23L 29/212; A23L 33/115; A23L 33/22; A23L 33/105

(52) U.S. Cl. CPC A23C 20/025; A23L 25/30; A23L 33/105; A23L 33/115; A23L 33/22; A23L 29/212

(57) ABSTRACT

The invention relates to a vegetable Cream Cheese, that is to say a product formulated with vegetable raw materials that reproduces the features of a dairy Cream Cheese in terms of texture and organoleptic profile.

The present invention relates to the field of the food industry; it is aimed more particularly at the preparation of food products composed of vegetable ingredients and having organoleptic properties similar to those of dairy products.

The demand for vegetarian or even vegan food products is constantly growing, whether for ethical reasons or for nutritional reasons. However, there are food products whose manufacture requires by definition the use of ingredients of animal origin, as is the case of mammalian milk for the preparation of dairy products such as cheese.

The Applicant's objective is to develop food products similar to dairy products from vegetable raw materials in order to generate products that are compatible with a vegan diet while remaining in the organoleptic universe of dairy products such as cheese spread or cream cheese in terms of appearance, texture and taste.

The cheese is a category of fresh dairy products obtained from liquid milk, a colloidal medium composed of submicron-sized proteins, fat globules, sugars and mineral salts. The milk is potentially enriched with cream or other dairy derivatives and then subjected to a thermal treatment (thermization or pasteurisation) and/or physical treatment (microfiltration) in order to be coagulated by enzymatic (rennet) and/or microbiological (lactic bacteria in particular) means. The curd is then mechanically broken, drained and/or pressed and eventually ripened to produce a variety of cheeses such as soft cheeses, pressed cheeses, etc. . . . . The curds can also be mixed with other ingredients (milk proteins, cream, spices, herbs, etc.) and then subjected to thermo-mechanical treatments (e.g., homogenisation and pasteurisation) in order to obtain cheese specialities, which have a fresh cheese taste (or fresh cheese), a white colour, a smooth appearance and a spreadable texture.

The cheese analogues are defined as products obtained by mixing different ingredients such as proteins and fats, of dairy or non-dairy origin, and formulated to meet a specific functional need (Bachman, H. P., 2001, “Cheese analogues: a review”, International Dairy Journal, Volume 11, 505-515). Historically, these products were formulated with a view to reducing costs, in particular, with pizza cheeses. More recently, the segment of vegetable analogues aiming to reproduce the appearance and taste characteristics of different cheeses has experienced a strong commercial expansion, and different products are available on the market with various formulation strategies.

For example, vegetable Cream Cheeses obtained by emulsifying fat in an aqueous phase containing starches are known, as for example the branded products Violife, Nature & Moi and Green Vie. These products have a low protein content (between 0 and 1%) and their texturing is ensured by the joint use of fat (fluid and/or concrete), starches (native and/or modified) and hydrocolloids (xanthan, guar, carob, tara gum etc.). Acids (lactic E270, citric E330, sorbic E200) are also used.

In a similar way, some vegetable Cream Cheeses are formed by emulsifying fat in a continuous phase containing proteins, e.g. sunflower protein isolates (Coop Yolo) or lupin (Made with Luve—Prolupin). The protein content is higher (5-6%) and texturisation is ensured by the use of large quantities of concrete fat (27% copra in both cases). Texturing starches or vegetable fibres are also added.

The above products have a smooth texture because they are based on the use of fine particle size powders that are hydrated and then emulsified with fat. The copra (or coconut oil), a concrete fat rich in saturated fatty acids, is widely used, as well as various additives such as hydrocolloids (modified starches, xanthan, guar, carob, tara) and acids (sorbic, lactic, critical, malic). These products have limited nutritional value and usually contain several additives.

Another type of operation consists of using whole seeds, which have generally undergone a preparation treatment (shelling, optionally bleaching, thermal treatment or fermentation) and grinding them: certain vegetable Cream Cheeses are thus obtained from soya beans (Sojasun, Soyananda, Valsoia brand products) and contain between 2 and 4% protein and between 20 and 31% fat, with a majority of saturated fatty acids (18 to 23%) and optionally texturing additives.

A similar method can be used with cereals such as oats (Oatly products) or rice, methoded (by shelling, thermal treatment and optionally germination) and crushed and then mixed with fat, texturisers, starch and acidifiers with additive status. The fat content is around 20% with saturated fatty acid contents of between 7 and 17%.

Other vegetable cream cheeses are obtained from crushed nuts, in particular cashew nuts. It is known to use large quantities of crushed cashew nuts, add water and then ferment the suspension with lactic acid bacteria. Products from the brands New Roots, Nuttin Ordinary, Spread'em Kitchen Co, Treeline or Palace Culture correspond to this method of production. These products are high in protein (between 6 and 14%) and fat (between 23 and 32%) and contain no texturing or acidifying additives. The caloric value is high, usually between 250 and 400 kcal/100 g. The texture of these products is very often floury to grainy, unlike those of dairy referents which have a smooth appearance with no detectable particles in the mouth—with the exception of herbs or garlic particles which are deliberately visible to the naked eye.

It is also known to prepare vegetable Cream Cheeses starting from an almond juice, which is itself obtained by a thorough crushing of the almond to obtain a smooth anhydrous puree. This thorough crushing allows to pass from the powdery solid structure characteristic of almond powder to a liquid puree of low viscosity while remaining anhydrous. Such an almond puree does not contain any particles that can be detected in the mouth and therefore allows to restore the smooth character of dairy Cream Cheeses. However, its consistency is too fluid to be used in a Cream Cheese, which must be spreadable. Several solutions are known to thicken the almond puree to the consistency of dairy Cream Cheese. The Kite Hill brand products use a combination of texturing additives (xanthan gum, guar gum and locust bean gum) and tapioca starch to achieve the desired texture. The Simply V brand products use a combination of added concrete fat (copra) and a texturing additive, carob. The patent US20180242622A1 (Hochland) also describes the use of a specific method, combining thermal and mechanical treatment, in particular, homogenisation, to obtain a smooth vegetable Cream Cheese with a white colour. According to the authors, this method enables a highly aggregated microstructure to be obtained, composed of microgels trapping the fat and the finished product is characterised by a particular particle size distribution.

In conclusion, the almond-based vegetable Cream Cheeses of the prior art are stabilised by the addition of concrete fats and/or by the addition of texturing additives such as carob, guar, xanthan, etc., in the quantity and quality necessary to structure the product.

The objective of the Applicant is to obtain a smooth-textured vegetable cream cheese from crushed nuts, with a good nutritional profile and in particular a limited content of saturated fatty acids, without resorting to the addition of texturing additives such as gums and modified starches.

Vegetable Cream Cheese means a product formulated with vegetable raw materials that is as close as possible to a dairy Cream Cheese in terms of texture and organoleptic profile. In the remainder of the document, the term Cream Cheese will be used to describe this type of product.

Obtaining vegetable analogues of dairy products poses many technical problems. Unlike milk, which is a liquid, plant materials are cohesive solids often organized in a complex manner with well differentiated tissues having specific biological functions (e.g. germ and endosperm in a cereal). It is therefore difficult to obtain a smooth, unctuous and homogeneous product (on a scale of less than a millimetre) from plant particles larger than a centimetre and which tend to give pasty and/or granular products.

It is also difficult to obtain a product with a dairy or cheese-like character from vegetable raw materials, in particular the white colour which allows to recall the world of cheese.

Another problem is to be completely free of animal raw materials, such as milk proteins or eggs, the texturing, binding, gelling, stabilising, emulsifying, overrun, etc. functionality could be put to good use.

A similar technical problem is to have a finished product without additives such as emulsifiers, gums and other hydrocolloids (guar, xanthan, carob, carrageenan), ingredients commonly used in the vegan cheeses for their texturing and stabilising functionality: the texturants modify the rheological behaviour of Cream Cheese, making it more or less firm, spreadable, brittle, rheofluidifying, etc. . . . . They also have a stabilizing role through their ability to bind free water, thus limiting the risks of syneresis (water exudation) on the finished product, a phenomenon perceived as a quality defect. They also minimise the risk of obtaining a “floury” texture (granular or grainy structure) by limiting the interactions between proteins and fats that can lead to the formation of aggregates of a perceptible size in the mouth. The hydrocolloids are typically used at doses between 0.2 and 0.5 g/100 g, alone or in a mixture, which allows the formulator to adjust the level of texture of the Cream Cheese while guaranteeing the stability of this texture over time (Guinee, T. & Hickey, M., “Cream Cheese and Related Products”, 2009, in Dairy Fats and Related Products, Chapter 8, 195-256).

Another technical problem is the use of mostly fluid oils rather than concrete fats, which are solid at low temperatures and give Cream Cheese a creamy, melting texture. The use of concrete fats such as coconut oil, palm oil or cocoa butter is widespread in the world of vegetable cheese analogues: for example, the products Creamy Original (Violife), Simply V (Hochland) and Frischcreme (Bedda) contain between 20 and 30% copra, a fat that contains more than 90% saturated fatty acids (SFA) of the total fatty acids. This quantity and quality of fat (very concrete) generates a high level of texture after storage at a temperature of 10° C. or less: using a fluid oil instead at this temperature leads to a significant texture deficit that must be made up. No commercial product on the market meets both the constraint of using an almond puree without resorting to additives (hydrocolloids and/or acidifiers) or to concrete fats to structure and stabilise the Cream Cheese.

It is also difficult to obtain a Cream Cheese that has a sensory profile of dairy product and in particular the characteristic butter-cream notes. The flavouring profile often comprises detectable vegetal notes and may not be suitable for some consumers looking for a sensory experience similar to that of a dairy product.

Thanks to a specific selection of vegetable raw materials, coupled with a mastery of a method allowing the generation of Cream Cheeses, the Applicant has succeeded in preparing food products composed of vegetable raw materials and which present organoleptic qualities reproducing those of Cream Cheese spreads without additives while having an improved nutritional profile compared to dairy references and other vegetable analogues.

Advantageously, this selection of vegetable raw materials allows to offer products with a significant protein (greater than or equal to 3%) and dietary fibre (greater than or equal to 3%) content, a moderate fat (less than 20%) and saturated fatty acid (less than 8%) content, as well as “Clean Label” formulations, i.e., without food additives, with nutritional profiles superior to cheese equivalents, in this case by means of a Nutri-Score A to B. The Nutri-Score is a nutritional quality assessment tool introduced in 2016 in France as part of the National Nutrition and Health Plan. According to its nutritional characteristics, a food product obtains a Nutri-Score score ranging from A (the most nutritionally favourable products) to E (the least favourable products, whose consumption should be limited).

A real technical difficulty has arisen in offering products with a Nutri-Score A/B without additives (i.e., in particular without thickeners or stabilisers). Indeed, obtaining these Nutri-Score scores is dependent on the use of liquid oils (low saturated fatty acid content) which, in the absence of a stabiliser, makes the mixtures of materials potentially unstable (phase shift, sedimentation). The present invention is based on a choice of specific raw materials coupled with methods of mixing and shearing to refrain from using additives by remaining on A/B Nutri-Score.

The absence of texturing additives (agar, carob, xanthan, carrageenan, pectin, etc.) in the formulas also had to be compensated for by ingredients such as starch and/or flour. This compensation is not without consequences and has led to two new technical problems:
An organoleptic degradation of the product with an increase in undesirable vegetable tastes and odours and a loss of whiteness. In fact, in addition to the vegetable notes and colourings which are classically more pronounced in ingredients such as flour or starch than in texturing additive, the contents incorporated to produce a similar texturing effect are much higher, which makes the organoleptic defects of taste and colour even worse. It is therefore essential to choose ingredients that limit/remove these defects.
A greater evolution of texture during the life of the product with, in particular, phenomena of retrogradation of the starch observed, synonymous with a gain in firmness during conservation at 4-6° C.

The present invention also enables to solve the problem of the composition of most vegetable “cheeses” which contain very little (less than 1%) protein. The products according to the invention classically contain between 3 and 10% by weight of protein without requiring the addition of protein concentrate or isolate and therefore have an improved nutritional profile compared to the vegan cheeses of the prior art, with Nutri-Score scores of A to C for the preferred values.

Finally, the present invention allows to circumvent the problems of taste, colour and texture defects frequently found in vegetable cheese analogues. Contrary to the products currently on the market, the products resulting from this invention are very close to the dairy equivalents on these 3 criteria.

Obtaining smooth and tasty textures for Vegan products with a vegetable protein content of more than 3% without texturing or stabilising agents remains a major technical difficulty. The present invention thus allows to respond to this problem via the implementation of formulas and methods that generate textures without floury defects.

Similarly, the white appearance of a Vegan product with significant protein content is a real difficulty but remains an essential element to recall the cheese equivalent. There are many Vegan products on the market with a white appearance but based on formulations such as water+oil+texturing, and therefore without protein. Here again, in order to overcome this technical difficulty, formulas (choice of the right raw materials) and methods (mixing and homogenising steps) have allowed to achieve an appearance identical to that of a dairy cream cheese.

The present invention thus relates to a vegetable food product similar to Cream Cheese, comprising:
crushed nuts, preferably in the form of a puree and preferably almond puree; with the addition of:
at least one vegetable fat;
at least one source of starch; and
at least one source of vegetable dietary fibres; and
water;

characterised in that it contains no added additives and in that it has a median particle size D50 of less than 50 microns, preferably less than 40 microns, more preferably less than 30 microns.

More specifically, the present invention relates to a vegetable food product comprising (percentages expressed by weight with respect to the total weight of the product):
from 5 to 40%, preferably between 10% and 30% and more preferably about 15%, of crushed nuts preferably in the form of a puree. The particles of said puree have a median particle size measured by laser granulometry of less than or equal to 50 μm;
from 5 to 35% of vegetable fat, preferably from 5 to 30% and even more preferably from 5 to 20%;
up to 8% of saturated fatty acids, preferably up to 5%, still more preferably up to 3%;
from 0.5 to 20%, preferably from 1 to 15%, even more preferably from 3 to 10%, in particular about 3%, of a source of starch such as vegetable flour or starch;
up to 30% of other raw materials, preferably vegetable, such as vegetable or fruit purees or pieces, seeds or herbs, flavourings;
up to 8% of vegetable dietary fibres;
optionally adding a natural source of calcium such as Lithothamnium;
according to the calcium content of the Lithothamnium powder used, this ingredient may be added to a content of between 0.5 and 1%;
up to 3.5% of acidifier of the concentrated lemon juice type; according to a particular embodiment which does not use a natural source of calcium, the acidifier may be used in a lower content which may be up to 1.2%;
up to 1.5%, preferably less than 1% of food salt;
optionally, up to 1% of ferments; if the ferment is used to ferment all or part of the crushed nut, its content may be reduced to 0.2%;
water, between 50% and 75%, preferably around 65%.

This product is characterised by:
a dry extract content of between 20 and 50%, preferably between 30 and 45%;
a pH of between 4.0 and 5.2;
characteristics of a fresh dairy product, in particular white colour, smooth appearance, spreadable rheology, low granular texture and a fresh to fermented/acidic taste.

By spreadable, we mean a rheological behaviour known as “elastoplastic”, i.e., initially elastic at low deformations and then becoming plastic beyond a threshold stress called the flow threshold. This rheological behaviour is common to margarines, peanut butters, mayonnaise sauces, cream cheeses, etc., and allows the consumer to spread them effortlessly on a surface using a knife.

This spreading nature can advantageously be characterised using the so-called scissometric method (Vane method). The principle of the method is to press a fin-type geometry (consisting of a thin cylindrical axis on which 4 to 8 rectangular blades are arranged in a regular and symmetrical manner with respect to the axis) into the product to be studied and then to rotate it at a low constant speed (Daubert, C., Tkachuk, J. A and Truong, V. D., 1998, “Quantitative measurement of food spreadability using the Vane method”, Journal of Texture Studies, 29, 427-435). The stress first increases linearly with time (and therefore the deformation, corresponding to the elastic behaviour), then passes through a maximum, corresponding to the flow threshold, and decreases again, indicating plastic behaviour, characterised by large and irreversible deformations beyond the threshold. This type therefore provides two indicators of this elastoplastic behaviour: the flow threshold (homogeneous to a stress, therefore expressed in Pascal, noted Pa) and the deformation at which the threshold is observed (which can be expressed in different ways).

The Cream Cheese according to the invention is characterised by a flow stress of between 0.4 and 5 kPa and an angular deformation of between 0.1 and 0.4 radians.

By low granularity texture is meant a particle size distribution with a median diameter of less than 50 microns, which is the order of magnitude of particles that are sensorially perceptible in the mouth.

The particle size distributions present in almond purees and Cream Cheese were determined by laser particle sizing, using commercial equipment such as Malvern 3000 and Horiba LA 960. The principle of the laser particle sizing is to measure the light intensity scattered by the sample at different angles and to derive by calculation the ideal particle size distribution that would scatter the same scattered intensity profile. The good practice for this method is described in detail in ISO 13320:2020 (Particle size analysis —Laser Diffraction Methods) and has been followed, also incorporating advice from the skilled person.

Once the particle size distribution has been calculated, it is possible to determine the median size of the particles, noted D50, which corresponds to the median diameter of the distribution, averaged by volume. By definition, 50% of the distribution has a size smaller than D50 and 50% has a value greater than 50%.

For the determination of the particle size of the nut purees, they were dispersed at 10% in sunflower oil under agitation for 30 minutes and then incorporated into the measuring cell of the particle sizer. Due to the lack of contrast between the nut fat and the continuous phase, only the nut wall particles are detected. As these are sufficiently opaque, the Fraunhofer approximation was used to establish a size distribution.

For the determination of the particle size in the Cream Cheese, the sample was first diluted to 10% in distilled water and left under agitation for 30 minutes before being injected into the measuring cell for a series of at least 5 repetitions which were then averaged. The analysis was carried out using the Mie model with a value of 1.33 for the refractive index of water and values of 1.47 and 0.001 for the real and imaginary parts of the refractive index of the particles respectively.

Preferably, this food product does not contain any other ingredient than those listed above and detailed below; in particular, it is free of any product of animal origin, in particular proteins, lactose, and food additive.

Food additive means a substance added to food for technological purposes: to improve its conservation, to reduce oxidation phenomena, to colour foodstuffs, to reinforce their taste, etc. It may be colouring agents (including bleaching agents), conservatives, anti-oxidants, acidifiers/acidity correctors and texture agents (stabilisers, emulsifiers, thickeners, gelling agents). The use of food additives is governed by the Regulation (EC) No 1333/2008 and these substances are identified by a code in the format “E” followed by a number.

The food product according to the invention is also free of any soy-based ingredients. In addition, the food product according to the invention does not contain any protein isolate or concentrate, whether of animal or vegetable origin, nor any cereal or legume milk.

Nuts: the food product according to the invention consists of a base of one or more nuts, for example chosen from: almonds, hazelnuts, walnuts, cashew nuts, pecans, Brazil nuts, Macadamia nuts, alone or in a mixture; preferably, it is a nut puree, preferably of white almonds. A puree is a preparation of finely crushed nuts without any added ingredient, preferably resulting from a very fine grinding method (median particle size of less than 50 μm) and carried out on pruned, blanched and unroasted nuts.

According to a preferred embodiment, the vegetable food product according to the invention is prepared with a blanched almond puree with particle sizes of less than 50 μm and allows a smooth and white texture to be obtained. The choice of this raw material is also coupled with a mixing and shearing method which enables to offer textures that are perfectly smooth in the mouth without any floury defects.

According to the desired firmness of the finished product, the almond puree content can be modulated to reduce or increase the dry extract and particularly the fat and protein content.

Vegetable fat: different sources of vegetable fats can be used: oils such as rapeseed oil, sunflower oil, olive oil, grape seed oil, linseed oil, hempseed oil, etc., and concrete fats such as copra, cocoa butter, shea butter, etc. A mixture of different vegetable fats can be used.

The choice of the vegetable fat(s) depends on their saturated fatty acid content, which affects the nutritional profile of the finished product, as well as their colour and organoleptic profile.

Thus, the fats are chosen so that the saturated fatty acid content of the Cream Cheese does not exceed 8%, preferably 5%, even more preferably 3% by weight with respect to the total weight of the finished product.

According to a preferred embodiment, the vegetable fats used in the context of the invention are fluid vegetable oils, i.e., fats which are liquid at room temperature (about 20° C.) and therefore have a very low saturated fatty acid content (below 15%, preferably 10%). For example, the saturated fatty acid content is less than 10% for rapeseed oil, less than 12% for linseed oil and less than 15% for sunflower oil; advantageously and despite the known sensitivity of oils to oxidation and the various thermal treatments carried out during the preparation of the product (pasteurisation of the mix and hot dosing), the finished product in its packaging is stable over time and no rancid note is perceptible at the end of conservation; preferably, the vegetable oil is chosen from among the rapeseed oil, the sunflower oil and the olive oil or a mixture thereof.

As with the nut puree, the percentage of fat used directly impacts the texture/firmness of the finished product.

Ferments: These can be used to add taste and/or acidity to the mixture, replacing all or part of the acidifier. Various ferments can be incorporated into the formulation and are known to the person skilled in the art. In particular, it may be mesophilic lactic ferments (Lactococcus lactis ssp lactis and/or cremoris, Lactococcus lactis ssp lactis biovar diactylactis, Leuconostoc lactis and/or Leuconostoc mesenteroides) or thermophilic (Streptococcus thermophilus, Lactobacillus delbrueckii ssp bulgaricus and/or Lacticaseibacillus casei and/or Levilactobacillus brevis and/or Lacticaseibacillus rhamnosus and/or Lacticaseibacillus paracasei), ferments of the Geotrichum candidum or Penicillium camemberti type or Pediococcus pentosaceus, Pediococcus acidilactici, Lactiplantibacillus plantarum, or yeasts alone or in mixtures.

The ferments can be added at different steps of the method in the form of a leaven composed of fermented vegetable raw material. It is also possible to add the concentrated ferments directly to the cooled product before dosing.

Various lactic ferments can be used, including commercial products such as Danisco® VEGE Cultures (IFF-DuPont N&B), HOLDBAC® YM VEGE (IFF-DuPont N&B), Yoflex® (Chr Hansen) alone or in combination with LGG® (Chr Hansen) or BB-12® (Chr Hansen).

The addition of ferments to the product according to the invention does not have the effect of texturing it by a coagulation phenomenon for example.

In the case of the preliminary preparation of a fermented vegetable matrix, also called leaven, this can be obtained as follows: a nut or a mixture of nuts, in the form of a crushed or pureed product, preferably almond puree, is added with water so as to obtain a mixture containing 5 to 30% of nuts and then thermally treated in order to eliminate the indigenous flora. This mixture is then fermented to obtain a sourdough, as described in the example 5. This base is inoculated with one or more microorganisms, preferably lactic acid bacteria, known by the skilled in the art as being able to bring dairy notes, including “fresh” and/or “cream” and/or “butter” and/or goat notes to the fermented product by fermentation. These cocktails of strains may be composed of one or more strains, of one or more species among the following species Lactococcus lactis ssp lactis and/or cremoris, Lactococcus lactis ssp lactis biovar diactylactis, Leuconostoc lactis and/or Leuconostoc mesenteroides, Streptococcus thermophilus, Lactobacillus delbrueckii ssp bulgaricus, Lacticaseibacillus casei, Levilactobacillus brevis, Lacticaseibacillus rhamnosus, Lacticaseibacillus paracasei, Pediococcus pentosaceus, Pediococcus acidilactici, Lactiplantibacillus plantarum, or yeast alone, or in a mixture.

The mixture is then incubated at a temperature favouring the growth of the inoculated microorganism(s) within a temperature range of 20° C. to 45° C. The incubation time is between 15 and 48 hours.

The leaven is then incorporated, for example when mixing the vegetable materials for the preparation of Cream Cheese, in an amount of 5 to 60% of the final mixture.

Source of starch: This ingredient can be chosen from rice flour, chickpea flour, pea flour, bean flour, lupin flour, lentil flour, chestnut flour, rice starch, wheat starch, corn starch, tapioca starch, potato starch, etc. Preferably, rice flour or potato or manioc starch is used.

Because of its starch-rich composition (80%), rice flour is an interesting ingredient to offer Clean Label products, without additives. Its white appearance and relatively neutral taste compared to other flours enables to obtain products that are very similar in appearance and taste to Cream Cheese. Finally, the absence of gluten and its non-allergenicity are interesting properties.

For the same reasons, potato or manioc starch is an ingredient of interest to offer smooth and melting textures without strong impact on the colour and the taste.

In addition to hot viscosity and organoleptic properties, another criterion that can be taken into account for the choice of rice flour and/or starch references is the differences in retrogradation observed. The retrogradation is a phenomenon of recrystallisation of starch (composed of amylopectin and amylose chains) during the conservation which leads to a progressive hardening of the product, whose texture becomes less supple and more crumbly, which is not always desired and which may not be appreciated by the consumer.

Several references of flour and starch have been tested and have clearly shown significant differences in behaviour during the ageing of the products. This difference may be due to the origin of the product, its composition, or the preparation method used by the supplier. The choice of the type, origin and reference of the sources of starch can have impacts on the texture and taste of the product that the skilled person will be able to adjust according to his objectives and preferences, in relation to the desired shelf life and mode of use of the product.

The references showing the least retrogradation over time are preferred in the context of the present invention in that they ensure the stability of the texture of the Cream Cheese during the conservation at 4° C.-10° C.

Thus, when the rice flour is used, pregelatinised rice is preferably chosen.

In order to prepare food products according to the invention of the overrun type, it is advantageous to use potato or manioc starch as a source of starch (see example 4).

Other preferably vegetable raw materials: these raw materials are distinct from the other vegetable ingredients in the recipe (nut puree, oil, flour or starch, fibres); they complement the other vegetable ingredients listed and may be chosen from among garlic, herbs, Provencal herbs, spices, seeds, vegetables, calcium such as lithothamnium extract, fruits and cereals in the form of inclusions, pastes or purees, flavourings (for example to give a typical cream, butter, goat, emmental, cheddar, sheep), etc.

Vegetable dietary fibres: the food fibres that can be used in the context of the invention are:
the soluble fibres with low texturing properties, such as chicory fibres (inulins and fructooligosaccharides), resistant dextrins or any other indigestible oligosaccharide of vegetable origin, having a low molar mass, a neutral taste, a high solubility in water and a limited tendency to recrystallisation; and/or
the insoluble or partially soluble fibres, provided that they have a particle size and shape which makes them undetectable in the mouth and a low water retention capacity; preferably, non-texturing soluble fibres are used.

A mixture of several vegetable dietary fibres may be used.

The use of vegetable fibres advantageously enables to formulate products with a Nutri-Score score of A.

In particular, the inulin (chicory fibre) can be added to products where a melting and creamy texture is desired.

The choice of the reference and the origin of the fibres can have an impact on the texture and taste that the person skilled in the art can adjust according to his objectives and preferences.

Acidifier: concentrated lemon juice or concentrated grapefruit juice or other citrus fruits is preferred, more preferably concentrated lemon juice. This ingredient enables to obtain a final pH of the product between 4.0 and 5.2 corresponding to that of the dairy products in the Cream Cheese universe.

Nutritional composition of the Cream Cheese according to the invention:

TABLE 1

| | | | | Of which | | |
|---|---|---|---|---|---|---|
| | | | | saturated | | |
| | Energy | Protein | Fat | fatty acids | Carbohydrates | Fibre |
| | (kcal) | (%) | (%) | (%) | (%) | (%) |
| Range | 150-350 | 3-12 | 8-32 | 1-8 | 1-20 | 0.5-8 |

The Cream Cheese according to the invention has the following characteristics:
a colour that is as white as possible in order to match the cheese codes;
a smooth and melting texture, without any floury defects; this is obtained in particular thanks to a particle size of the Cream Cheese which has a median particle size D50 of less than 50 microns, preferably less than 40 microns, more preferably less than 30 microns;
a taste as dairy as possible, without any undesirable vegetable taste.

Flavoured versions with marked colours, going beyond the known codes of cheese, can of course be envisaged, for example with the addition of vegetable raw material from carrots, beetroot, green beans, etc . . . .

The addition of herbs or plants can also be envisaged to offer flavoured versions of the Garlic & Fine Herbs type for example.

The method for preparing the product according to the invention comprises the following steps:
A) optionally, fermenting some or all of the crushed nuts, in their rehydrated and thermally-treated form prior to the inoculation of the ferments;

The objective of this step is to improve the organoleptic profile of the finished product by providing a cheese/dairy typicity. The nuts are preferably almonds.

The fermented product thus obtained can be added at the step B) or between the steps D) and G).
B) mixing of the raw materials via vigorous shearing and, optionally, preheating e.g., via steam injection or a double-walled device;

This step allows the hydration of the ingredients, in particular the powders, until a generally liquid and homogeneous suspension is obtained; it is preferably carried out at a temperature of between 20 and 65° C., for 1 to 30 minutes, with moderate to high agitation in a cooker or stirred tank; preferably, this step is carried out in a cooker at approximately 50° C., for 5 minutes with moderate agitation.
C) thermally treating the mixture at a temperature of between 75 and 90° C., for example with steam injection or double wall, for 1 to 10 minutes under vigorous shearing;

This step allows the functionalization of the ingredients and the pasteurization of the raw materials; it is preferably carried out at 82° C. for 2 minutes.

The mixture can then optionally be transferred to a buffer tank and maintained at a temperature of between 70° C. and 85° C.
D) optional degassing and homogenising;

This step is preferably carried out at between 50 bar and 600 bar, preferably 300 to 500 bar.

This step allows, among other things, a whiter colouring of the paste and the obtaining of a stable emulsion and the reduction of the size of the particles in order to make the texture smooth.
E) optionally, overrun to produce an aerated texture;

This step allows to generate an aerated texture to increase the gluttony; it can be conducted by nitrogen injection on a continuous overrun device with overrun rates between 0% and 30%.

The overrun rate for a given volume is defined as the difference between the mass of non-overrun product and the mass of overrun product, this value being related to the mass of non-overrun product and expressed in %.
F) optionally, adding other raw materials, preferably vegetable (herbs, flavouring ingredients, markers, fermented vegetable raw material . . . );

Depending on the overrun technologies, the steps E) and F) may be reversed.
G) hot dosing the finished product into its packaging or into an intermediate container (barrel/goatskin container/pouch, etc.); the hot dosing is carried out at a temperature above 70° C., preferably between 74 and 80° C.;
H) cooling to between 4 and 10° C.;
I) optionally in the case of dosing in an intermediate container, adding other raw materials, preferably vegetable (flavouring) and/or ferments, followed by cold dosing the product in its final packaging.

The ingredients can be added between 4 and 20° C., preferably at 10° C. This embodiment requires a choice of flavouring ingredients with a low microbial load to ensure microbiological stability during the product's conservation. The addition of ferments allows to improve the organoleptic profile of the product and/or the microbial stability of the finished product. The choice of appropriate ferments is known to the skilled person.

The table below shows the unit operations that can be implemented in the method according to the invention and indicated in the following examples:

TABLE 2

| | | | Preferred values |
|---|---|---|---|
| | | | (implemented in the |
| Unitary step | Function | Possible values | following examples) |
| Fermentation of | Improve the | Fermentation of nuts | Fermentation of |
| raw materials | organoleptic profile | | almond juice |
| (optional step) | of raw materials by | | |
| A | providing | | |
| | cheese/dairy typicity | | |
| Rehydration, | Mix the various | Mixing temperature | Cooker, mix 5 min at |
| Mixing and | ingredients to obtain | between 20 and 65° C. | 50° C. |
| Preheating | an overall liquid and | Mixing time between 1 | |
| (optional) of | homogeneous | min and 30 min | |
| ingredients | suspension | Cooker, stirred tank | |
| B | | | |
| Pasteurisation | Functionalisation of | 75° C. to 90° C. | 82° C., 2 min |
| C | ingredients through | From 1 to 10 minutes | |
| | thermal treatment | | |
| | and pasteurisation of | | |
| | raw materials | | |
| Degassing | Stable emulsion, | 50-600 bars | 300-500 bars |
| (optional) and | particle size | | |
| Homogenisation | reduction for smooth | | |
| D | texture and texturing | | |
| | lever | | |
| Overrun | Generate an aerated | Nitrogen injection on a | Adjust according to |
| (Optional step) | texture to increase | overrun device with | the chosen overrun |
| E | gluttony | parameters known to the | rate (0-30%) |
| | | skilled person | |
| Injection of | Provide markers | No limits for flavouring. | |
| ingredients | and/or flavouring | Max marker size | |
| (Optional step) | | depending on the dosing | |
| F | | nozzles | |
| Dosage (final | Dosing the product | Hot dosing > 70° C. | Hot dosing |
| packaging or | | | temperature |
| barrel) | | | between 72° C. |
| G | | | and 80° C. |
| Cooling | Cooling and | T° C. = 4° C.-10° C. | Storage temperature |
| H | texturing the | | between 4° C. and |
| | product to obtain a | | 10° C. |
| | base or a finished | | |
| | product | | |
| Injecting | Providing markers or | T° C. = 4-20° C. | T° C.: 10° C. |
| ingredients | flavourings or | | |
| (Optional step) and | ferment(s) for | | |
| dosing in the final | flavouring and/or | | |
| packaging | improving the | | |
| I | conservation of the | | |
| | product | | |

### FIGURES

FIG. 1 is a photograph of the product of example 1, which is a non-overrun vegetable Cream Cheese;

FIG. 2 is a graphical representation of the sensory evaluation of the Cream Cheese of example 5.

### EXAMPLES

### Example 1

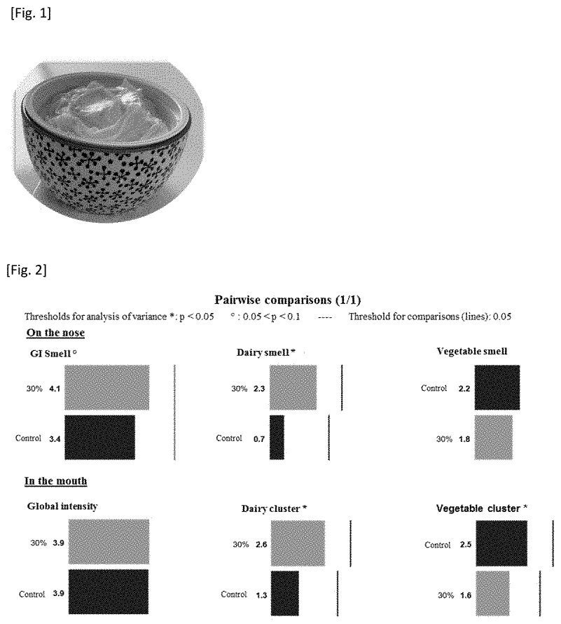

(FIG. 1): the Cream Cheese product is composed of 60% water, 15% almond puree, 10% rapeseed oil, 10% rice flour, 2.5% inulin, 1% NaCl, 1.5% concentrated lemon juice.

The method comprises the following steps from table 2 described above, namely

B-C-D-G-H

A finished product is obtained that has the appearance of a fresh dairy paste, with a smooth, white spreadable texture (see FIG. 1). The product has a pH of 4.7 and can be conserved before opening for several weeks (70 days) at a temperature of 4 to 10° C. without showing any noticeable change in texture or taste.

The nutritional values of the product of Example 1 are given below:

TABLE 3
Content per 100 g

| | |
|---|---|
| Energy (kcal) | 234 |
| Protein | 4 |
| Carbohydrates | 12.5 |
| Of which sugars | 0.9 |
| Fat | 18 |
| Of which Saturated Fatty Acids | 2 |
| Fibre | 3 |

The addition of ingredients such as herbs, garlic or spices is a variant of this Nature formula, these ingredients being added in step F.

The steps B) and C) can be carried out with a Stephan or Karl-Schnell type cooker using shear parameters known to the skilled person. In this particular case, the two mixing steps were carried out at 1500 rpm.

### Example 2

The Cream Cheese product is composed of 61.6% water, 13% almond puree, 8% rapeseed oil, 3% copra, 11% rice flour, 1% inulin, 1.2% NaCl, 1% concentrated lemon juice, 0.2% natural flavour.

The method comprises the following steps from Table 2 described above, namely:

B-C-D-G-H.

As in the Example 1, the addition of herbs, garlic, spices or other flavouring ingredients (vegetables, fruits) is a variant of this Nature formula, these ingredients being added in step F.

### Example 3

Product composed of 58.9% water, 15% almond puree, 10% rapeseed oil, 10% rice flour, 2.5% inulin, 1.5% potato starch, 0.7% NaCl, 0.9% concentrated lemon juice and 0.5% of a commercial Lithothamnium powder

The addition of herbs, garlic or spices is a variant of this formula.

The method then comprises the following steps from table 2 described above: B-C-D-F-G-H or even B-C-D-G-H-I.

### Example 4—Cream Cheese Overrun

Product composed of 65.1% water, 19% almond puree, 8% rapeseed oil, 4.5% potato starch, 3.5% inulin, 0.8% NaCl, 1.3% concentrated lemon juice.

The addition of ingredients such as herbs, garlic or spices is a variant of this formula.

The method used in this example is the one corresponding to the preferred values in the table 2 described above, namely: B-C-D-E-G-H or (if ingredients are added): B-C-D-E-F-G-H or if a fermentation step is added: A-B-C-D-E-F-G-H.

### Example 5

In the following example, the almond puree with added water was inoculated and fermented with a strain of the species Lactococcus lactis ssp lactis biovar diacetylactis. The resulting mixture was fermented at 30° C. for 24 hours to obtain what will be called a leaven.

The leaven was then incorporated in step B) at a rate of 30% into the final mixture.

An unleavened product was also made for comparison. The composition of the two products is equivalent and is summarised in the following table:

TABLE 4

| | Product with 30% leaven | Product without leaven |
|---|---|---|
| Ingredients | incorporated | incorporated |
| Almond puree | 10.5% | 15% |
| Fermented leaven | 30% | 0 |
| (15% almond puree + | | |
| 85% water) | | |
| Total almond puree | 15% | 15% |
| Oil | 10% | 10% |
| Rice flour | 10% | 10% |
| Inulin | 2.5% | 2.5% |
| Salt | 1% | 1% |
| Lemon juice | 1.5% | 1.5% |
| Water | 34.5% | 60% |

The method used is that of Example 1.

Both products were made on the same day.

In this example, the nature of the flavour and taste interest provided by the Cream Cheese leaven was evaluated and validated by a sensory evaluation carried out with a panel of 10 judges according to a “double blind” protocol, i.e. the judges were not aware of the project, the nature of the problem and the nature of the samples. The order of tasting was also different and randomly assigned to each judge. Two Cream Cheese products were compared in this evaluation: the Cream Cheese product with 30% leaven (“30%” in the graph in FIG. 2) and the Cream Cheese product without leaven (“Control” in the graph in FIG. 2). They were evaluated by smell and then by tasting according to three criteria: Global flavouring intensity, dairy intensity and vegetal intensity. The judges were asked to describe the nature of the flavour and taste notes perceived in smell and tasting as well.

According to the graphical data in FIG. 2, the judges perceived the product with leaven to be significantly more dairy in smell and taste than the unleavened product. They also perceive the product with leaven to be significantly less vegetable than the unleavened product.

The judges describe the product with leaven as having “butter”, “cream”, and “almond” notes in smell and “dairy”, “sour cream”, “light almond” in taste. The unleavened product is described as “vegetable”, “almond”, “cooked” in smell and “almond” in mouth.

These data allow us to validate the flavouring gain brought by the leaven to the product: a dairy component is added. A reduction in the vegetable and almond notes is also perceived in the mouth.

### Example 6: Characterisation of the Rheology of Products According to the Invention

Several publications are available on the rheological characterisation of dairy Cream Cheeses with this method and have been compared in Table 5.

All these measurements were carried out at a temperature of 5° C. and with a rotation speed of 0.05 rd/s (publication (1) and present application) or 0.06 rd/s (publication (2)):

TABLE 5

| | Flow | Angular | |
|---|---|---|---|
| | Threshold | Deformation | |
| Product | (kPa) | (rd) | Source |
| Kraft Philadelphia Regular | 4.4 | 0.24 | (1) |
| Kraft Philadelphia Neufchatel | 2.7 | 0.43 | (1) |
| Kraft Philadelphia Whipped | 1.3 | 0.63 | (1) |
| Kraft Philadelphia | 2.2 | 0.23 | (2) |
| Product according to the | 2.0 ± 0.5 | 0.28 ± 0.06 | |
| invention Example 1 | | | |
| Product according to the | 1.2 ± 0.3 | 0.18 ± 0.03 | |
| invention Example 4 (overrun) | | | |

(1) Breidinger, S. L. and Steffe, J. F., 2001, “Texture Map of Cream Cheese”, Journal of Food Science, 66, no 3, 453-456.
(2) Coutouly, A., Riaublanc, A., Axelos, M., Gaucher, I., 2014, “Effect of heat treatment, final pH of acidification and homogenization pressure on the texture properties of Cream Cheese”, Dairy Science & Technology, 94, 125-144.

The products according to the invention give values close to Kraft Foods' Philadelphia product, a product considered the benchmark in the Cream Cheese category, which confirms the spreading nature of the products according to the invention.

1. A vegetable food product similar to Cream Cheese, comprising:
crushed nuts, preferably in the form of a puree;
with the addition of:
at least one vegetable fat;
at least one source of starch;
at least one source of vegetable dietary fibres;
a natural acidifying ingredient; and
water;
wherein the vegetable food product contains no added additives and has a median particle size D50 of less than 50 microns.

2. The vegetable food product according to claim 1, further comprising (percentages expressed by weight with respect to the total weight of the product):
from 5 to 40% of crushed nut puree;
from 5 to 30% of vegetable fat;
up to 8% of saturated fatty acids;
up to 1.5% of food salt;
optionally, up to 1% of ferments;
0.5% to 20% of a source of starch;
up to 30% of other raw materials such as vegetable or fruit purees or pieces, cereals, seeds, flavours, Lithothamnium powder or herbs;
up to 8% of vegetable dietary fibres;
up to 3.5% of acidifier such as concentrated lemon juice; and
between 50% and 75% water.

3. The vegetable food product according to claim 1, further comprising (percentages expressed by weight with respect to the total weight of the product):
from 10 to 30% of crushed nut puree;
from 5 to 20% of vegetable fat;
up to 3% saturated fatty acids;
up to 1% of food salt;
optionally, up to 1% of ferments;
1% to 15% of a source of starch;
up to 30% of other raw materials such as vegetable or fruit purees or pieces, cereals, seeds, flavourings, Lithothamniun powder or herbs;
up to 8% of vegetable dietary fibres;
up to 1.2% acidifier such as concentrated lemon juice; and
between 50% and 75% water.

4. The vegetable food product according to claim 1, further comprising:
a dry extract content of between 20 and 50%; and
a white colour, a smooth appearance, a spreadable rheology, a smooth texture and a fresh to fermented/acidic taste.

5. The vegetable food product according to claim 1, wherein the nut is almond.

6. The vegetable food product according to claim 1, wherein the vegetable fat is a fluid vegetable oil.

7. The vegetable food product according to claim 6, wherein the fluid vegetable oil is selected from rapeseed oil, sunflower oil or olive oil or a mixture thereof.

8. The vegetable food product according to claim 1, wherein the source of starch is rice flour and/or potato or manioc starch.

9. The vegetable food product according to claim 8, wherein the rice flour is pregelatinised.

10. The vegetable food product according to claim 1, wherein the vegetable dietary fibres are selected from non-texturizing soluble fibres including inulin, fructooligosaccharides, and resistant dextrins and or any other indigestible oligosaccharide of low molar mass, soluble and having a neutral taste.

11. A method for preparing the product according to claim 1, comprising the following steps:
A) optionally, preparing a fermented vegetable raw material by fermenting part or all of crushed nuts, in their rehydrated and thermally-treated form prior to inoculation of the ferments;
B) mixing the raw materials, which may include the fermented vegetable raw material obtained in step A), via vigorous shearing, and optionally preheating;
C) thermally treating the mixture at a temperature between 75 and 90° C. for 1 to 10 minutes under vigorous shearing;
D) optional degassing and homogenising;
E) optionally overrun;
F) optionally, adding raw materials, preferably vegetable;
steps E) and F) can be reversed;
G) hot dosing at a temperature above 70° C. of the finished product in its packaging or in an intermediate container;
H) cooling between 4 and 10° C.; and
I) optionally, in the case of dosing in an intermediate container, adding other raw materials, including vegetable flavouring, and/or ferments and then cold dosing the product into its final packaging.

12. The vegetable food product according to claim 2, further comprising (percentages expressed by weight with respect to the total weight of the product):
from 10 to 30% of crushed nut puree;
from 5 to 20% of vegetable fat;
up to 3% saturated fatty acids;
up to 1% of food salt;
optionally, up to 1% of ferments;
1% to 15% of a source of starch;
up to 30% of other raw materials such as vegetable or fruit purees or pieces, cereals, seeds, flavourings, Lithothamniun powder or herbs;
up to 8% of vegetable dietary fibres;
up to 1.2% acidifier such as concentrated lemon juice; and
between 50% and 75% water.

13. The vegetable food product according to claim 2, further comprising:
a dry extract content of between 20 and 50%; and
a white colour, a smooth appearance, a spreadable rheology, a smooth texture and a fresh to fermented/acidic taste.

14. The vegetable food product according to claim 3, further comprising:
a dry extract content of between 20 and 50%; and
a white colour, a smooth appearance, a spreadable rheology, a smooth texture and a fresh to fermented/acidic taste.

15. The vegetable food product according to claim 2, wherein the nut is almond.

16. The vegetable food product according to claim 3, wherein the nut is almond.

17. The vegetable food product according to claim 4, wherein the nut is almond.

18. The vegetable food product according to claim 2, wherein the vegetable fat is a fluid vegetable oil.

19. The vegetable food product according to claim 3, wherein the vegetable fat is a fluid vegetable oil.

20. The vegetable food product according to claim 4, wherein the vegetable fat is a fluid vegetable oil.
